(19) United States
(12) Patent Application Publication
(10) Pub. No.: US 2015/0185703 A1
(43) Pub. Date: Jul. 2, 2015

(54) ELECTRONIC DEVICE AND METHOD FOR DISPLAYING WATCH OBJECT

(71) Applicant: Kabushiki Kaisha Toshiba, Tokyo (JP)

(72) Inventor: Hideaki Tanaka, Ome Tokyo (JP)

(21) Appl. No.: 14/493,689

(22) Filed: Sep. 23, 2014

Related U.S. Application Data
(60) Provisional application No. 61/921,330, filed on Dec. 27, 2013.

(51) Int. Cl. G04G 9/00; G04G 99/00

(52) U.S. Cl. CPC G04G 9/0005; G04G 99/006

(57) ABSTRACT

According to one embodiment, an electronic device includes a display, a memory to store a plurality of image data corresponding to a plurality of watch objects, and processing circuitry. The processing circuitry cyclically switches a watch object to be displayed on the display among first watch objects of the plurality of watch objects, by using the plurality of image data. The first watch objects are watch objects which have the same design of a face and have different colors of at least a first part of the face.

### CROSS-REFERENCE TO RELATED APPLICATIONS

This application claims the benefit of U.S. Provisional Application No. 61/921,330, filed Dec. 27, 2013, the entire contents of which are incorporated herein by reference.

### FIELD

Embodiments described herein relate generally to a technique of displaying an object on a display.

### BACKGROUND

In recent years, with the development of electronic technology, various small-sized, light-weight electronic devices have been gaining in popularity. Some typical electronic devices are a tablet, a smartphone, and a PDA.

Recently, electronic devices with a smaller size, which can always be worn and used, have begun to be developed.

It is expected that such small-sized electronic devices will be used hereafter for various uses closely related to everyday life of users.

Recently, various small-sized displays with high image quality have also been developed. Accordingly, techniques for effectively using the capability of displays are required.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an electronic device according to an embodiment.

FIG. 2 is an exemplary block diagram illustrating a system configuration of the electronic device of the embodiment.

FIG. 3 is a view illustrating examples of a plurality of kinds of watch objects, which are automatically switched by the electronic device of the embodiment.

FIG. 4 is a view illustrating examples of a pair of watch objects, which are automatically switched by the electronic device of the embodiment.

FIG. 5 is an exemplary view illustrating a setup screen which is used in the electronic device of the embodiment.

FIG. 6 is a view for describing an example of a watch object automatic switching operation which is executed by the electronic device of the embodiment.

FIG. 7 is a view for describing another example of the watch object automatic switching operation which is executed by the electronic device of the embodiment.

FIG. 8 is an exemplary flowchart for describing the procedure of a watch object select operation which is executed by the electronic device of the embodiment.

FIG. 9 is an exemplary flowchart for describing the procedure of a watch object automatic switching process which is executed by the electronic device of the embodiment.

FIG. 10 is an exemplary flowchart for describing the procedure of a process of specifying a watch object set which is to be used in the watch object automatic switching process of FIG. 9.

### DETAILED DESCRIPTION

Various embodiments will be described hereinafter with reference to the accompanying drawings.

In general, according to one embodiment, an electronic device comprises a display, a memory to store a plurality of image data corresponding to a plurality of watch objects, and processing circuitry. The processing circuitry cyclically switches a watch object to be displayed on the display among first watch objects of the plurality of watch objects, by using the plurality of image data. The first watch objects are watch objects which have the same design of a face and have different colors of at least a first part of the face. A color of the first part of the face of each of the first watch objects is expressed by a combination of an R-level, a G-level and a B-level. The R-level, the G-level and the B-level of the first part of the face of each of the first watch objects are determined such that an average of the R-level of the first parts of the faces of the first watch objects becomes a first value, an average of the G-level of the first parts of the faces of the first watch objects becomes the first value, and an average of the B-level of the first parts of the faces of the first watch objects becomes the first value.

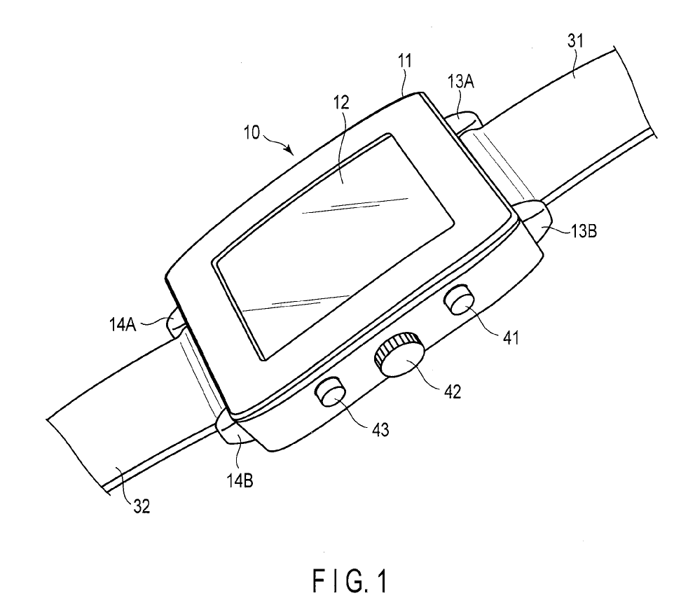

FIG. 1 is a perspective view illustrating an external appearance of an electronic device according to an embodiment. This electronic device is a portable electronic device including a display. Hereinafter, the case is assumed in which the electronic device is realized as an intelligent watch (smart watch) which can execute various functions including a wristwatch function.

This intelligent watch 10 is a battery-drivable, small-sized computing device. The intelligent watch 10 includes a main body 11. The main body 11 is composed of a thin housing. In the housing, various electronic components are provided. A display 12 is disposed on an upper surface of the main body 11. The display 12 may be, for instance, an organic EL display. In addition, the display 12 may include a touch panel which can detect a position of contact with the screen of the display 12.

The intelligent watch 10 includes a belt 31, 32, by which the main body 11 can be put on the human body (arm). One end of the belt 31 is attached to an upper end of the main body 11 by attachment portions 13A, 13B. One end of the belt 32 is attached to a lower end of the main body 11 by attachment portions 14A, 14B.

Some operation buttons are provided on a side surface, for example, a right side surface, of the main body 11. The case is illustrated in which three operation buttons, namely an operation button 41, an operation button 42 and an operation button 43, are provided on the right side surface of the main body 11. The operation button 42 may be a crown.

The intelligent watch 10 can execute various functions, as described above. At a usual time, however, the intelligent watch 10 is configured to execute the wristwatch function. The wristwatch function is a function for displaying a watch object on the display 12, thereby causing the display 12 to appear as if it were a real wristwatch. The watch object is an image representative of a watch. The watch object may be displayed on the entire screen of the display 12.

The watch object includes an image representative of a watch face. Images of some hand objects (an hour hand, a minute hand, a second hand) are moved in a manner to rotate on the face.

In the meantime, if the same watch object continues to be displayed on the display 12 for a long time, it is possible that the screen of the display 12 is damages and a phenomenon which is called burn-in is observed. In a self-luminous display such as an organic EL display, each pixel (light emission element) degrades in accordance with the total light emission amount thereof. A difference in degradation among the light emission elements causes a phenomenon called burn-in.

A screen saver is widely known as a measure to prevent burn-in. However, to execute the screen saver while a device is idling leads to a factor of an increase in power consumption of the device. The intelligent watch 10 is required to operate for a long time by one-time charging of a built-in battery. Thus, the screen saver is not suitable for the intelligent watch 10.

Taking the above into account, in the present embodiment, a watch object automatic switching function is provided in order to prevent burn-in of the screen of the display 12. The watch object automatic switching function is a function for automatically changing the watch face which is displayed on the display 12.

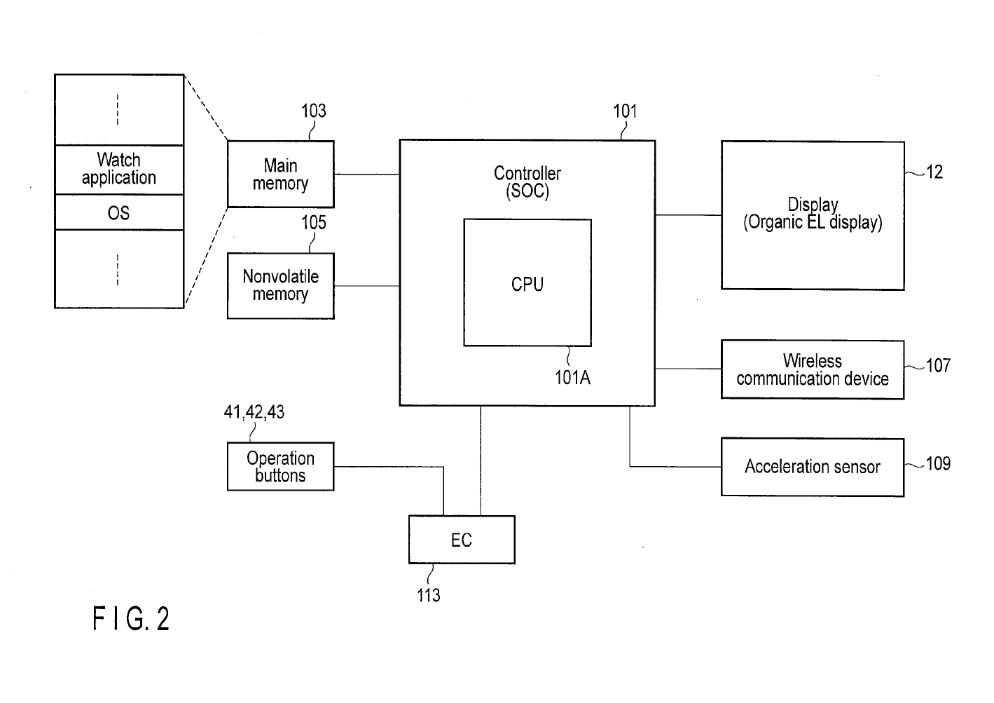

FIG. 2 illustrates a system configuration of the intelligent watch 10.

The intelligent watch 10 includes a controller 101, a main memory 103, a nonvolatile memory 105, a wireless communication device 107, an acceleration sensor 109, and an embedded controller (EC) 113.

The controller 101 is arranged to execute various functions including the above-described wristwatch function. The controller 101 controls various components in the intelligent watch 10. The controller 101 may be realized by an SOC (System-on-a-chip) including various processing circuitry including a CPU 101A. The CPU 101A functions as a processor (one or more cores) configured to execute various programs which are loaded from the nonvolatile memory 105 into the main memory 103.

These programs include an operating system and various application/utility programs. The application/utility programs include a watch application program. The watch application program is a program for executing the above-described wristwatch function. Further, the application/utility programs may include an application program for cooperation with other electronic devices (e.g. a smartphone). This application program can display various information pieces, such as mail reception notifications and contents of incoming mail, on the display 12.

The controller 101 executes the above-described watch object automatic switching function, under the control of this watch application program. Specifically, the controller 101 cyclically switches a watch object to be displayed on the display 12 between a plurality of watch objects which are prepared in advance. These watch objects are watch objects which have the same design of the face and have different colors of at least a first part of the face. Examples of the first part of the face may include a background of the face, an index, a hand, and other various objects on the face.

In the intelligent watch 10, a plurality of image data corresponding to a plurality of watch objects are prestored in the nonvolatile memory 105. The controller 101 does not change an image, which is representative of a specific face, by an image signal process, but the controller 101 switches the watch object, which is to be displayed on the display 12, between the plural watch objects by using the plural image data. In other words, the watch face, which is displayed on the display 12, is automatically changed by selectively using the plural image data. Since exclusive image data is prepared in advance for each watch face, all of the plural kinds of watch faces having different colors can be finely displayed. In addition, compared to the case of executing an image signal process for varying the color and brightness of the image, the watch face which is displayed on the screen of the display 12 can automatically changed with a lighter arithmetic load.

In the intelligent watch 10, a plurality of image data sets corresponding to a plurality of watch object sets, which have different designs of the watch face, may be prestored in the nonvolatile memory 105. Each of the watch object sets is a set of a plurality of watch objects having the same design of the face and having different colors of at least the first part of the face.

In this case, in the watch object automatic switching function, the watch object, which is displayed on the display 12, may be switched between watch objects belong to the same watch object set.

The operation button 41, 42 or 43 may function as a user interface which is configured to select a watch object, which is to be used as the watch face of the intelligent watch 10, from a plurality of watch objects in accordance with a user's operation. For example, each time the operation button 41 is operated by the user, the controller 101 may execute a process of switching the watch object, which is to be used as the watch face, to another watch object. In the case where the display 12 includes a touch panel, this touch panel-equipped display 12 may function as the above-described user interface for selecting, from the plural watch objects, the watch object that is to be used as the watch face. The user can select a desired watch object (watch face) by operating the operation button 41, 42 or 43, or by performing a gesture (flick gesture) of sliding a finger upward or downward in a state in which the finger is put in contact with the display 12.

When the above-described watch object automatic switching function is enabled, the controller may switch the watch object, which is displayed on the display 12, between only some watch objects including faces having the same design as the face of the watch object selected by the user.

The controller 101 may automatically switch the watch object, which is displayed on the display 12, between plural watch objects, at a rate of once in a predetermined time (e.g. 24 hours, or 12 hours).

Alternatively, the controller 101 may control the switching timing of the watch object which is displayed on the display 12, by taking into account the total display time of each watch object, so that the actual display periods of these plural watch objects may become equal. The controller 101 includes a sleep function. Thus, the display 12 is set in an OFF state after the intelligent watch 10 has transitioned into an idle state, and is set in an ON state in response to a wakeup event. Examples of the wakeup event include an event in which the operation button has been operated, an event in which the display 12 has been touched, and an event in which the intelligent watch 10 has been shaken.

The controller 101 measures the total time in which a certain watch object is displayed on the display 12 which is in the ON state. On the display 12 which is in the ON state, in some cases, other information, such as a mail view screen, may be displayed instead of the watch object. Thus, in the process of measuring the total time, it is preferable to exclude from the total time a time in which the watch object is not displayed. Then, when the measured time (a cumulative value of display time) has reached a predetermined time, the controller 101 switches a watch object, which is to be displayed on the display 12, from the watch object which is currently displayed to another watch object.

The wireless communication device 107 is a communication interface module for wirelessly communicating with another electronic device (e.g. smartphone). The wireless communication device 107 may be, for instance, a Bluetooth (trademark) module. The controller 101 cooperates with another electronic device by making use of the wireless communication device 107, and thereby the controller 101 can display various information pieces on the display 12.

The acceleration sensor 109 may function as a sensor configured to detect that the intelligent watch 10 has been shaken.

The embedded controller (EC) 113 is configured to execute a power management function for powering on or powering off the intelligent watch 10 in accordance with an operation by the user.

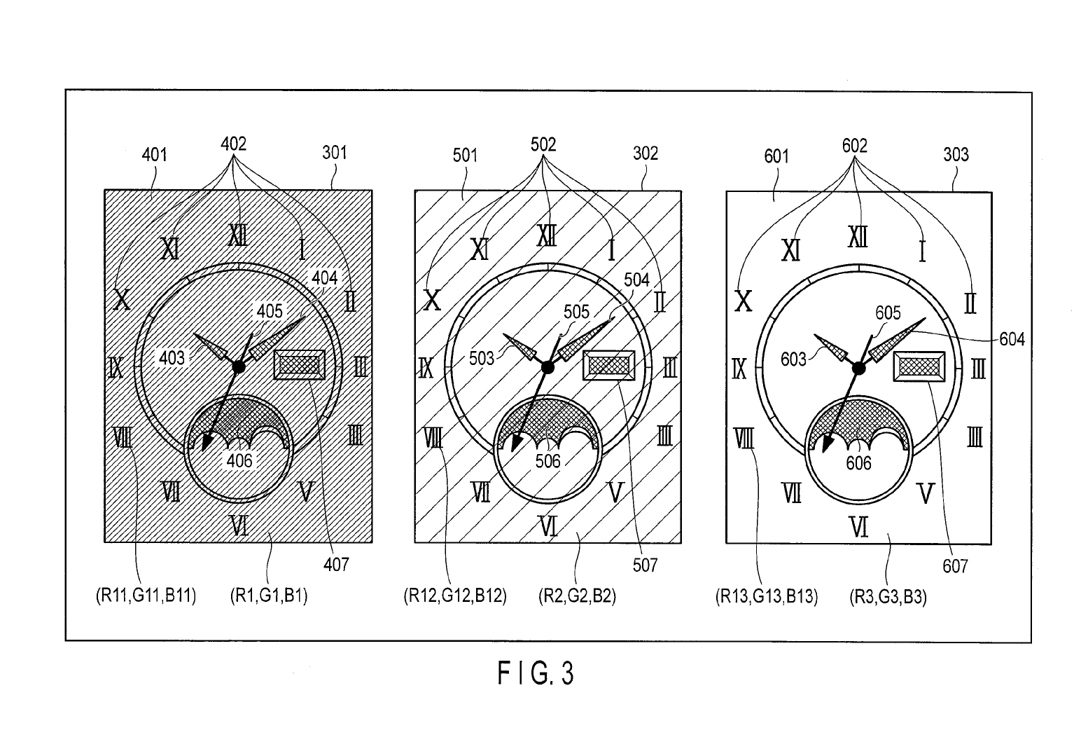

FIG. 3 illustrates examples of a plurality of kinds of watch objects, which are automatically switched by the intelligent watch 10. The case is now assumed in which the watch object, which is displayed on the display 12, is switched between three watch objects 301, 302 and 303 at predetermined time intervals.

The watch objects 301, 302 and 303 are watch objects which have the same design of the face and have different colors of at least a first part of the face. As described above, examples of the first part include a background of the face, a hand, and other various objects.

To begin with, the watch object 301 is described.

A face 401 of the watch object 301 is an image representative of the watch object 301. The watch object 301 includes a plurality of kinds of objects which are arranged on the face 401. These objects, too, are images representative of parts of the watch object 301. These objects include an index 402, an hour hand object 403, a minute hand object 404, a second hand object 405, a moon phase object 406, and a date window 407.

The index 402 is information (scale marks, numbers) for expressing a time cycle. In FIG. 3, numbers expressed by Roman numerals are arranged as part of the index on the face 401. Further, some scale marks are arranged as part of the index in the vicinity of the numbers.

Each of the hour hand object 403, minute hand object 404 and second hand object 405 is an image representative of a hand of the watch. The hour hand object 403 moves on the face 401 in a manner to make a single rotation in 12 hours. The minute hand object 404 moves on the face 401 in a manner to make a single rotation in one hour. The second hand object 405 moves on the face 401 in a manner to make a single rotation in one minute.

The moon phase object 406 is also a moving object. The date window 407 displays information relating to the present date (e.g. a year, a month, a day, a day of the week).

Next, the watch object 302 is described.

A face 501 of the watch object 302 is an image representative of the watch object 302. The face 501 has the same design as the face 401 of the above-described watch object 301. The watch object 302 includes a plurality of kinds of objects which are arranged on the face 501. These objects include an index 502, an hour hand object 503, a minute hand object 504, a second hand object 505, a moon phase object 506, and a date window 507. The shapes, sizes and positions of the index 502, hour hand object 503, minute hand object 504, second hand object 505, moon phase object 506 and date window 507 are the same as the shapes, sizes and positions of those of the watch object 301.

Next, the watch object 303 is described.

A face 601 of the watch object 303 is an image representative of the watch object 303. The face 601, too, has the same design as the face 401 of the above-described watch object 301. The watch object 303 includes a plurality of kinds of objects which are arranged on the face 601. These objects include an index 602, an hour hand object 603, a minute hand object 604, a second hand object 605, a moon phase object 606, and a date window 607. The shapes, sizes and positions of the index 602, hour hand object 603, minute hand object 604, second hand object 605, moon phase object 606 and date window 607 are the same as the shapes, sizes and positions of those of the watch object 301.

Next, a description is given of colors of the faces of the watch objects 301 to 303. In the description below, the case is assumed in which the above-described first part of the face is the background of the face.

The color of the background of each of the faces 401, 501 and 601 is expressed by a combination of an R (red)-level, a G (green)-level, and a B (blue)-level. The case is now assumed in which each of R-level, G-level and B-level is expressed by eight levels from level 0 to level 7. Level 7 corresponds to a maximum luminance level of each sub-pixel (R sub-pixel, G sub-pixel, B sub-pixel) of the display 12.

The R-level, G-level and B-level of the background of each of the faces 401, 501 and 601 are determined so as to satisfy the following three color conditions.

Color condition 1: an average of the R-level of the backgrounds of the faces 401, 501, 601 becomes a first value V1.

Color condition 2: an average of the G-level of the backgrounds of the faces 401, 501, 601 becomes the above-described first value V1.

Color condition 3: an average of the B-level of the backgrounds of the faces 401, 501, 601 becomes the above-described first value V1.

The color conditions 1 to 3 are expressed by the following equations (1), (2) and (3).

(R1+R2+R3)÷3=V1 (1)

(G1+G2+G3)÷3=V1 (2)

(B1+B2+B3)÷3=V1 (3)

In this case, (R1, G1, B1) represents the color of the background of the face 401, (R2, G2, B2) represents the color of the background of the face 501, and (R3, G3, B3) represents the color of the background of the face 601. V1 may be about ½ of the maximum luminance level of each sub-pixel of the display 12, for example, about 3.5.

By cyclically switching the watch object, which is to be displayed, between the watch objects 301 to 303 which meet these color conditions, the light emission amounts of the pixels in the display area of the display 12, which corresponds to the background of the face, can be made uniform. To be more specific, the total light emission amounts of the R sub-pixels, G sub-pixels and B sub-pixels included in the display area of the display 12, in which the background of the face is displayed, can be made substantially equal. As a result, it is possible to obtain the same advantageous effect as in the case where these sub-pixels have emitted light at the same luminance level in the same time. Therefore, the occurrence of a phenomenon such as burn-in can efficiently be prevented.

Next, the case is assumed in which the above-described first part is the index of the face.

The indices 402, 502 and 602 have different colors. The R-level, G-level and B-level of each of the indices 402, 502 and 602 are determined so as to satisfy the following three color conditions.

Color condition 1: an average of the R-level of the indices 402, 502, 602 becomes the above-described first value V1.

Color condition 2: an average of the G-level of the indices 402, 502, 602 becomes the above-described first value V1.

Color condition 3: an average of the B-level of the indices 402, 502, 602 becomes the above-described first value V1.

The color conditions 1 to 3 are expressed by the following equations (4), (5) and (6).

(R11+R12+R13)÷3=V1 (4)

(G11+G12+G13)÷3=V1 (5)

(B11+B12+B13)÷3=V1 (6)

In this case, (R11, G11, B11) represents the color of the index 402, (R12, G12, B12) represents the color of the index 502, and (R13, G13, B13) represents the color of the index 602. V1, as described above, may be about ½ of the maximum luminance level of each sub-pixel of the display 12.

By cyclically switching the watch object, which is to be displayed, between the watch objects 301 to 303 which meet these color conditions, the light emission amounts of the pixels in the display area of the display 12, which corresponds to the index (numerals or marks for expressing time) of the face, can be made uniform.

The watch objects 301 to 303 may be watch objects which have not only different colors of the background of the face and different colors of the index, but also have different colors of the hand object and different colors of the moon phase object.

In the meantime, since the hand object and moon phase object are moving objects, the colors of these may not necessarily be different between the three watch objects. This is because the moving object is hardly affected by burn-in. In this case, the color of the hand object may be determined from the standpoint of design, in consideration of the color of the background of the face.

Since the movement of the moon phase object 406, 506, 606 is relatively slow, the color of the moon phase object 406, 506, 606 may be set to be a relatively dark color, for instance, dark blue. Thereby, the total light emission amount of the display area in the screen, which corresponds to the moon phase objects, can be suppressed to be low.

Information relating to the date, which is displayed by each of the date windows 407, 507, 607, is dynamically changed. Thus, the colors of these date windows (colors of backgrounds, colors of characters) may not necessarily be different between the three watch objects. In this case, the color of the background of the date window 407, 507, 607 may be set to be a relatively dark color, for instance, black or dark blue.

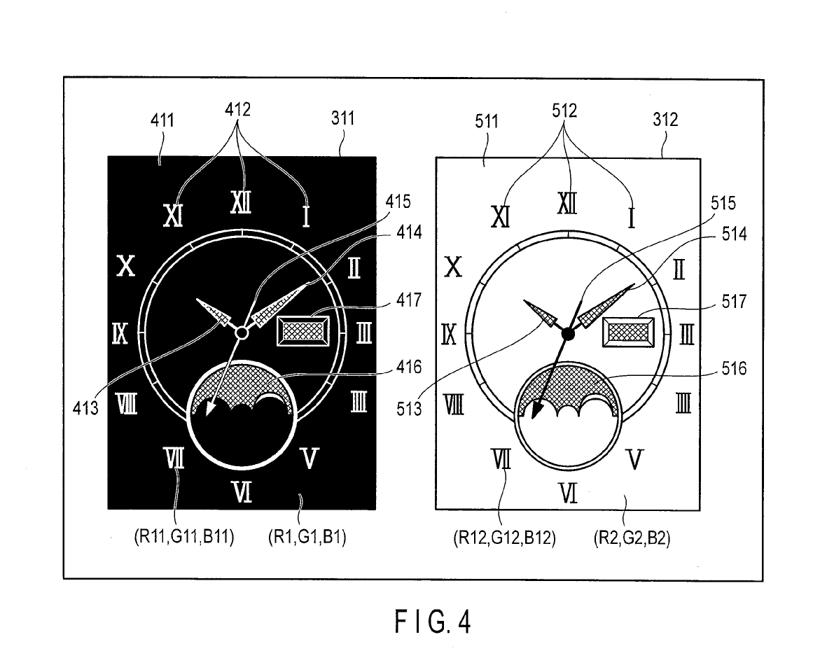

FIG. 4 illustrates examples of a pair of watch objects, which are automatically switched by the intelligent watch 10. The case is now assumed in which the watch object, which is to be displayed on the display 12, is alternately switched between two watch objects 311 and 312 at predetermined time intervals.

As described above, each pixel (light emission element) degrades in accordance with the total light emission amount thereof. Accordingly, a display control process of displaying, after a face of a certain first color is displayed, a face of a second color, which is a complementary color of the first color, is effective in order to prevent burn-in.

Thus, in the present embodiment, the following two watch objects 311 and 312 are used.

The watch objects 311 and 312 are watch objects which have the same design of the face and have different colors of at least a first part of the face. The case is now assumed in which the first part includes a background of the face, and an index.

The shapes, sizes and positions of an index 412, an hour hand object 413, a minute hand object 414, a second hand object 415, a moon phase object 416 and a date window 417 on a face 411 of the watch object 311 are the same as the shapes, sizes and positions of an index 512, an hour hand object 513, a minute hand object 514, a second hand object 515, a moon phase object 516 and a date window 517 on a face 511 of the watch object 312.

The color of the background of the face 411 of the watch object 311 and the color of the background of the face 511 of the watch object 312 have a relationship of complementary colors. Similarly, the color of the index 412 of the watch object 311 and the color of the index 512 of the watch object 312 may have a relationship of complementary colors.

In the watch object 311, the color of the background of the face 411 and the color of the index 412 are different. The color of the index 412 may be a complementary color of the color of the background of the face 411. In the watch object 312, the color of the background of the face 511 and the color of the index 512 are different. The color of the index 512 may be a complementary color of the color of the background of the face 511.

The R-level, G-level and B-level of the background of each of the faces 411 and 511 are determined so as to satisfy the following three color conditions.

Color condition 1: an average of the R-level of the backgrounds of the faces 411 and 511 becomes the above-described first value V1.

Color condition 2: an average of the G-level of the backgrounds of the faces 411 and 511 becomes the above-described first value V1.

Color condition 3: an average of the B-level of the backgrounds of the faces 411 and 511 becomes the above-described first value V1.

The color conditions 1 to 3 are expressed by the following equations (7), (8) and (9).

(R1+R2)÷2=V1 (7)

(G1+G2)÷2=V1 (8)

(B1+B2)÷2=V1 (9)

In this case, (R1, G1, B1) represents the color of the background of the face 411, and (R2, G2, B2) represents the color of the background of the face 511. V1 may be about ½ of the maximum luminance level of each sub-pixel of the display 12.

The color of the background of the face 411 may be, for example, black. In this case, (R1, G1, B1) is (0, 0, 0). The color of the background of the face 511 may be white, which is the complementary color of black. In this case, (R2, G2, B2) is (7, 7, 7). When (R2, G2, B2) is the complementary color of (R1, G1, B1), the following relationship is established.

R1+R2=7

G1+G2=7

B1+B2=7.

Accordingly, an average of the colors of the backgrounds in a case where the watch objects 311 and 312 are alternately displayed becomes about ½ of the maximum luminance level of each sub-pixel, i.e., (3.5, 3.5, 3.5).

The R-level, G-level and B-level of each of the indices 412 and 512 are determined so as to satisfy the following three color conditions.

Color condition 1: an average of the R-level of the indices 412 and 512 becomes the above-described first value V1.

Color condition 2: an average of the G-level of the indices 412 and 512 becomes the above-described first value V1.

Color condition 3: an average of the B-level of the indices 412 and 512 becomes the above-described first value V1.

The color conditions 1 to 3 are expressed by the following equations (10), (11) and (12).

(R11+R12)÷2=V1 (10)

(G11+G12)÷2=V1 (11)

(B11+B12)÷2=V1 (12)

Where (R11, G11, B11) represents the color of the index 412, and (R12, G12, B12) represents the color of the index 512. V1 may be a half level, for example, 3.5, of the maximum luminance level of each sub-pixel of the display 12.

The color of the index 412 may be, for example, white. In this case, (R11, G11, B11) is (7, 7, 7). The color of the index 512 may be black, which is the complementary color of white. In this case, (R12, G12, B12) is (0, 0, 0). When (R12, G12, B12) is the complementary color of (R11, G11, B11), the following relationship is established.

R11+R12=7

G11+G12=7

B11+B12=7.

Accordingly, an average of the colors of the indices in a case where the watch objects 311 and 312 are alternately displayed becomes (3.5, 3.5, 3.5).

In the example of FIG. 4, the color of the second hand 415 is also set to be the complementary color of the second hand 515. The color of the moon phase object 416, 516 is set to be a relatively dark color, for instance, dark blue. The color of the background of the date window 417, 517 is also set to be a relatively dark color, for instance, black or dark blue.

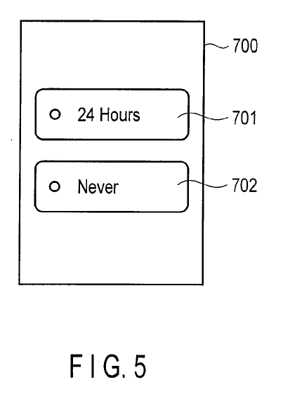

FIG. 5 illustrates a setup screen relating to the watch object automatic switching function.

The setup screen 700 is a user interface for permitting or prohibiting cyclic switching of the watch object which is displayed on the display 12. When a software button 701 has been selected by the user, the watch object automatic switching function is enabled. In this case, the watch object that is a display target is automatically switched at predetermined time intervals (e.g. 24 hours). When a software button 702 has been selected by the user, the watch object automatic switching function is disabled. In this case, the same watch object continues to be displayed.

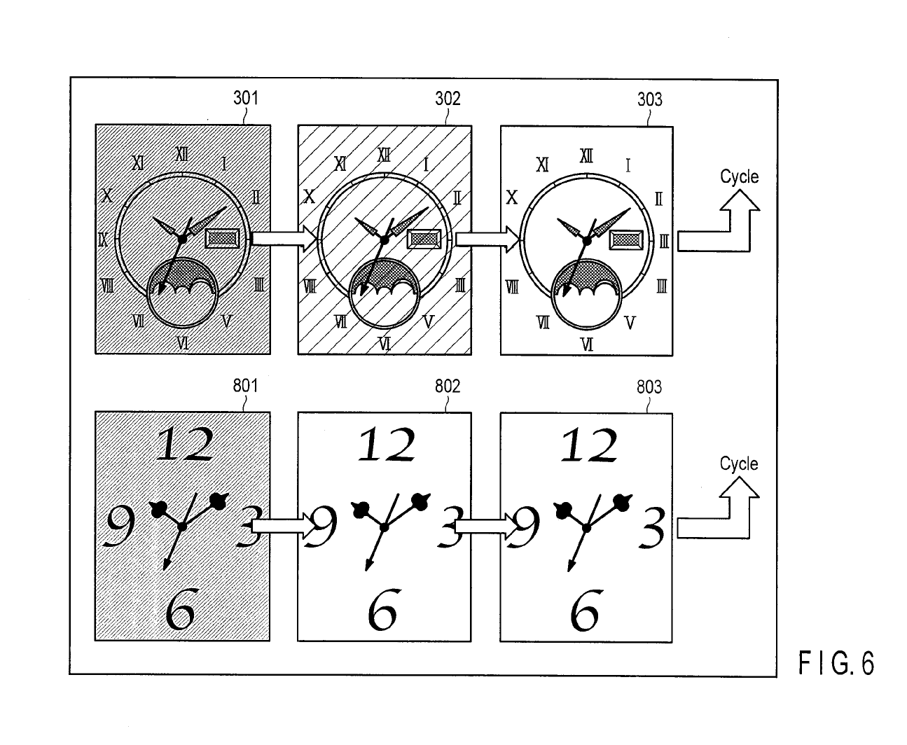

FIG. 6 illustrates an example of a watch object automatic switching operation.

The case is assumed in which two image data sets corresponding to two watch object sets are prestored in the nonvolatile memory 105.

A first watch object set includes the three watch objects 301, 302 and 303 which have been described in FIG. 3. A second watch object set includes three watch objects 801, 802 and 803. The watch objects 801, 802 and 803 are watch objects which have the same design of the face and have different colors of at least the first part of the face.

Six image data corresponding to the watch objects 301, 302, 303, 801, 802 and 803 are stored in the nonvolatile memory 105.

The first parts (the background of the face, the index, etc.) of the watch objects 801, 802 and 803 satisfy the three color conditions expressed by the above equations (1), (2) and (3), like the three watch objects 301, 302 and 303. The design of the watch objects 801, 802 and 803 is different from the design of the faces of the watch objects 301, 302 and 303.

The user can select an arbitrary watch object of these eight watch objects as the watch object that is to be used as the watch face. If the selected watch object belongs to the first watch object set, the controller 101 can automatically switch the watch object, which is to be displayed, between the watch objects 301, 302 and 303 belonging to the first watch object set, by using the image data set corresponding to the first watch object set. The image data set corresponding to the first watch object set includes three image data corresponding to the watch objects 301, 302 and 303.

On the other hand, if the selected watch object belongs to the second watch object set, the controller 101 can automatically switch the watch object, which is to be displayed, between the watch objects 801, 802 and 803 belonging to the second watch object set, by using the image data set corresponding to the second watch object set. The image data set corresponding to the second watch object set includes three image data corresponding to the watch objects 801, 802 and 803.

For example, when the selected watch object is the watch object 302, the controller 101 first starts the display of the watch object 302. When a predetermined time has passed since the start of display of the watch object 302, or when the total time in which the watch object 302 is displayed on the display 12 that is in the ON state has reached the predetermined time, the controller 101 switches the watch object that is to be displayed from the watch object 302 to the watch object 303. Then, when the predetermined time has passed since the start of display of the watch object 303, or when the total time in which the watch object 303 is displayed on the display 12 that is in the ON state has reached the predetermined time, the controller 101 switches the watch object that is to be displayed from the watch object 303 to the watch object 301.

In the meantime, when the watch object automatic switching function is disabled, the watch object selected by the user continues to be displayed.

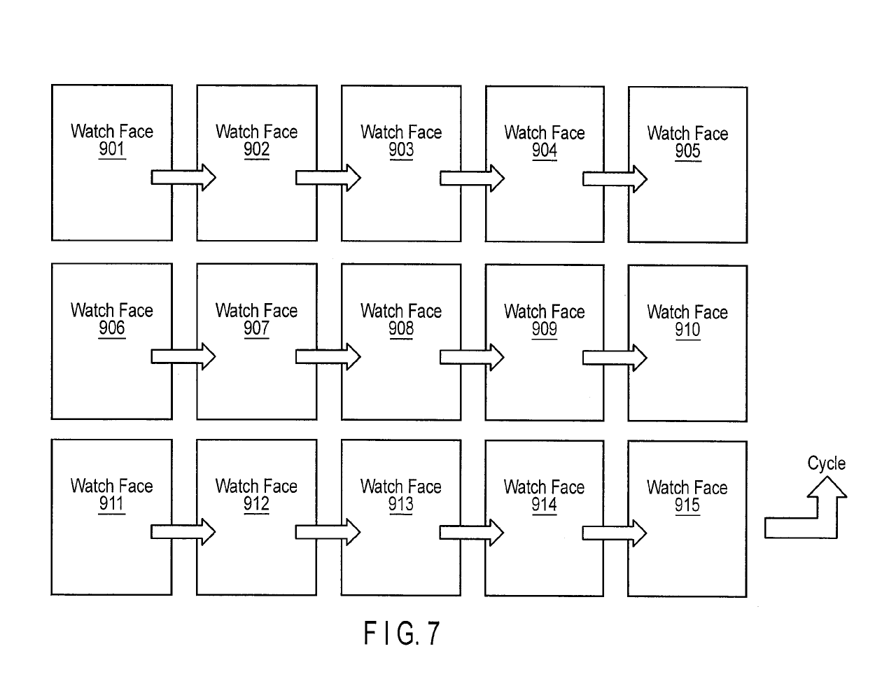

FIG. 7 illustrates another example of the watch object automatic switching operation.

The case is now assumed in which many image data corresponding to many watch objects 901 to 915, which have different designs or colors of the face, are prestored in the nonvolatile memory 105. In order to maintain high quality of the display 12 for a long time by preventing burn-in, it is preferable to switch the watch object, which is a display target, between a plurality of watch objects which satisfy the above-described color conditions. However, even in the case of using a simple method of cyclically switching the watch object that is the display target between the many watch objects 901 to 915, the difference in light emission amount between the pixels of the display 12 can be made smaller than in the case of continuing to display the same watch object.

In the meantime, the watch objects 901 to 905 may be such watch objects that the design of the face is a first design and the color of at least the first part of the face satisfies the above-described color conditions. Further, the watch objects 906 to 910 may be such watch objects that the design of the face is a second design that is different from the first design, and the color of at least the first part of the face satisfies the above-described color conditions. Besides, the watch objects 911 to 915 may be such watch objects that the design of the face is a third design that is different from the first and second designs, and the color of at least the first part of the face satisfies the above-described color conditions.

In the case where 15 image data corresponding to these watch objects 901 to 915 are stored in the nonvolatile memory 105, the user can select the watch object, which is to be used as the watch face, from among the watch objects 901 to 915.

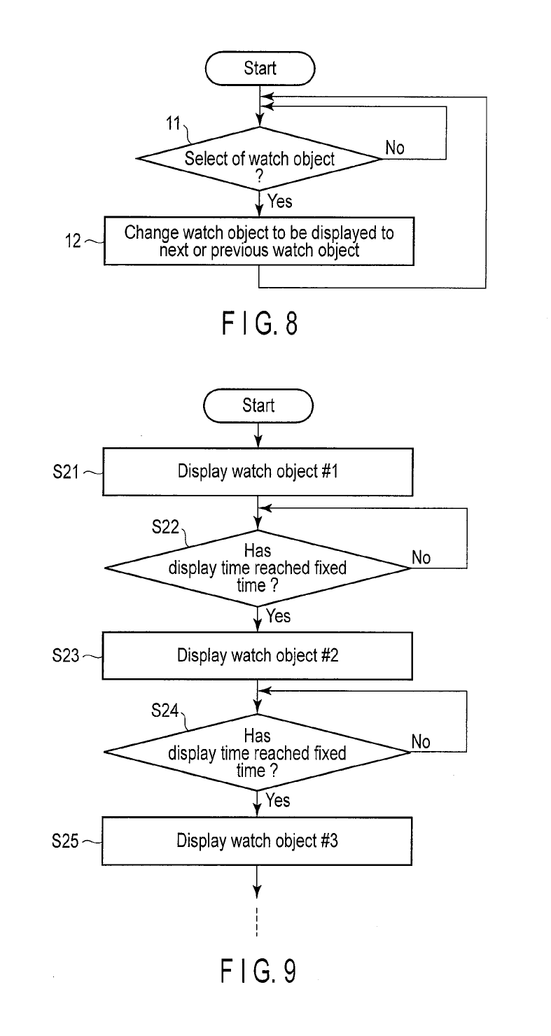

A flowchart of FIG. 8 illustrates the procedure of a watch object select operation which is executed by the controller 101.

The controller 101 determines whether a watch object select operation has been executed by the user (step S11). An example of the watch object select operation is a specific operation using the operation button 41, 42 or 43, or a flick gesture on the display 12. If the watch object select operation is executed (YES in step S11), the controller 101 advances to a process of step S12. In step S12, the controller 101 selects the next or previous watch object of the currently displayed watch object as the watch object which is to be used as the watch face. The next or previous watch object can be determined in the following manner.

The case is now assumed in which the watch objects 911 to 915, which have been described in FIG. 7, are stored in the nonvolatile memory 105. When the currently displayed watch object is the watch object 901, the watch object 902 is the next watch object of the watch object 901, and the watch object 915 is the previous watch object of the watch object 901. Whether the next or previous watch object is to be selected may be determined in accordance with the kind of button which is operated, or in accordance with a slide direction of a finger slide gesture.

Then, the controller 101 changes the watch object to be displayed (i.e. the watch object that is to be used as the watch face) to the selected watch object, and displays the selected watch object on the display 12.

A flowchart of FIG. 9 illustrates the procedure of a watch object automatic switching process for automatically changing the watch face.

The case is now assumed in which a watch object set including watch objects #1 to #3 is prepared in advance. These watch objects #1 to #3 have the same design of the face and have different colors of at least a first part of the face. Further, the colors of the first parts of the watch objects #1 to #3 are determined so as to satisfy the above-described color conditions.

The controller 101 first displays the watch object #1 on the display 12 (step S21). This watch object #1 is displayed based on image data #1 which is prestored in the nonvolatile memory 105.

The controller 101 determines whether a display time of the watch object #1 has reached a fixed time (step S22). In this case, as described above, the controller 101 may measure a total time in which the watch object #1 is actually displayed on the display 12 that is in the ON state, and may determine whether this total time has reached the fixed time. Alternatively, the controller 101 may determine that the display time of the watch object #1 has reached the fixed time, when an elapsed time from the start of display of the watch object #1 has reached the fixed time.

If the display time of the watch object #1 has reached the fixed time (YES in step S22), the controller 101 displays the watch object #2 on the display 12, in place of the watch object #1 (step S23). This watch object #2 is displayed based on image data #2 which is prestored in the nonvolatile memory 105.

The controller 101 determines whether a display time of the watch object #2 has reached the fixed time (step S24). If the display time of the watch object #2 has reached the fixed time (YES in step S24), the controller 101 displays the watch object #3 on the display 12, in place of the watch object #2 (step S25). This watch object #3 is displayed based on image data #3 which is prestored in the nonvolatile memory 105.

In this manner, the watch object, which is displayed on the display 12, is cyclically switched between the watch objects #1 to #3.

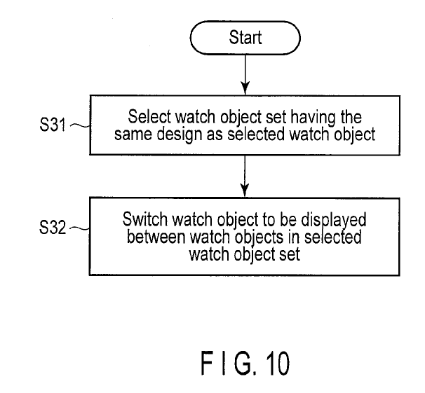

A flowchart of FIG. 10 illustrates the procedure of a process of specifying a watch object set which is to be used in the watch object automatic switching process of FIG. 9.

The case is now assumed in which some watch object sets are prepared in advance. As described above, the user can select the watch object which is to be displayed on the display 12, that is, the watch object which is to be used as the watch face of the intelligent watch 10, from a plurality of watch objects which are prepared in advance. The controller 101 displays the selected watch object on the display 12.

When the watch object automatic switching function is enabled, the controller 101 selects a watch object set having the same design as the selected watch object (step S31). This watch object set is a watch object set to which the selected watch object belongs. Then, the controller 101 cyclically switches the watch object, which is to be displayed, between the watch objects included in the selected watch object set (step S32).

As has been described above, in the present embodiment, a plurality of image data corresponding to a plurality of watch objects are prepared in advance. Using these image data, the controller 101 cyclically switches the watch object, which is displayed on the display 12, between first watch objects of the plurality of watch objects. The first watch objects may be some watch objects of the above-described plurality of watch objects, or may be all of the above-described plurality of watch objects.

The first watch objects are watch objects which have the same design of the face and have different colors of at least a first part of the face. The R-level, G-level and B-level of the first part of the face of each of the first watch objects are determined such that the average of the R-level of the first parts of the faces of the first watch objects becomes a first value, the average of the G-level of the first parts of the faces of the first watch objects becomes the first value, and the average of the B-level of the first parts of the faces of the first watch objects becomes the first value. Therefore, since the light emission amounts of the pixels in the display area of the display 12, which corresponds to the first part, can be made substantially uniform, the occurrence of a phenomenon such as burn-in can be suppressed.

The various processes of the embodiment can be realized by a computer program. Thus, the same advantageous effects as with the present embodiment can easily be obtained simply by installing the computer program into an ordinary computer through a computer-readable storage medium which stores the computer program, and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display;
a memory to store a plurality of image data corresponding to a plurality of watch objects; and
processing circuitry to cyclically switch a watch object to be displayed on the display among first watch objects of the plurality of watch objects, by using the plurality of image data,
wherein: each of the first watch objects has a same design of a face and has a different color for at least a first part of the face;
a color of the first part of the face of each of the first watch objects is expressed by a combination of an R-level, a G-level and a B-level; and
the R-level, the G-level and the B-level of the first part of the face of each of the first watch objects are determined such that an average of the R-level of the first parts of the faces of the first watch objects becomes a first value, an average of the G-level of the first parts of the faces of the first watch objects becomes the first value, and an average of the B-level of the first parts of the faces of the first watch objects becomes the first value.

2. The electronic device of claim 1, wherein the first value is about ½ of a maximum luminance level of each of sub-pixels of the display.

3. The electronic device of claim 1, further comprising a user interface to select a first watch object, which is to be used as a watch face, from the plurality of watch objects,
wherein each of the first watch objects includes a first face having the same design as the face of the selected first watch object.

4. The electronic device of claim 1, further comprising a user interface to permit or prohibit the cyclical switching of the watch object which is displayed on the display.

5. The electronic device of claim 1, wherein the first part of the face of each of the first watch objects includes a background of the face of each of the first watch objects.

6. The electronic device of claim 1, wherein the first part of the face of each of the first watch objects includes an index of the face of each of the first watch objects.

7. The electronic device of claim 1, wherein the display is an organic EL display.

8. The electronic device of claim 1, wherein the display is set in an OFF state after the electronic device has transitioned into an idle state, and is set in an ON state in response to a wakeup event, and
the processing circuitry measures a total time in which a first object of the first watch objects, which is currently displayed, is displayed on the display which is in the ON state, and when the total time has reached a first time, the processing circuitry switches the watch object, which is displayed on the display, from the first object to another object of the first watch objects.

9. The electronic device of claim 1, wherein the processing circuitry cyclically switches, at a rate of once in the first time, the watch object to be displayed on the display among the first watch objects.

10. A method for displaying a watch object on a display of an electronic device, the method comprising:
cyclically switching the watch object to be displayed on the display among first watch objects of a plurality of watch objects, by using a plurality of image data corresponding to the plurality of watch objects, the plurality of image data being stored in a memory of the electronic device,
wherein: the first watch objects have the same design of a face and have different colors for at least a first part of the face;
a color of the first part of the face of each of the first watch objects is expressed by a combination of an R-level, a G-level and a B-level; and
the R-level, the G-level and the B-level of the first part of the face of each of the first watch objects are determined such that an average of the R-level of the first parts of the faces of the first watch objects becomes a first value, an average of the G-level of the first parts of the faces of the first watch objects becomes the first value, and an average of the B-level of the first parts of the faces of the first watch objects becomes the first value.

11. A computer-readable, non-transitory storage medium having stored thereon a computer program configured to be executable by a computer, the computer program controlling the computer to execute a function of:
cyclically switching a watch object to be displayed on a display of the computer among first watch objects of a plurality of watch objects, by using a plurality of image data corresponding to the plurality of watch objects, the plurality of image data stored in a memory of the computer,
wherein: the first watch objects have the same design of a face and have different colors for at least a first part of the face;
a color of the first part of the face of each of the first watch objects is expressed by a combination of an R-level, a G-level and a B-level; and
the R-level, the G-level and the B-level of the first part of the face of each of the first watch objects are determined such that an average of the R-level of the first parts of the faces of the first watch objects becomes a first value, an average of the G-level of the first parts of the faces of the first watch objects becomes the first value, and an average of the B-level of the first parts of the faces of the first watch objects becomes the first value.
